(19) United States
(12) Patent Application Publication
(10) Pub. No.: US 2010/0147392 A1
(43) Pub. Date: Jun. 17, 2010

(54) Process and apparatus for thawing jelled diesel fuel

(76) Inventor: Dale A. Craddock, Great Bend, KS (US)

Correspondence Address: KENNETH W. ILES, 9903 West 129th Street, Overland Park, KS, 66213-3222, US

(21) Appl. No.: 12/660,055

(22) Filed: Feb. 19, 2010

(51) Int. Cl. F17D 1/00; F16K 49/00; F28D 7/00; B65D 88/12

(52) U.S. Cl. 137/2; 137/335; 137/340; 219/442; 220/562

(57) ABSTRACT

Jelled diesel fuel from a truck or the like is pumped into a heating tank where is it heated by hot propylene glycol that has been heated by a burner and that is circulated through heat exchangers in the heating tank. The fuel is heated to a preselected temperature and then returned to the truck's fuel tanks. The fuel filter is removed and a similar shaped shell installed in place of the fuel filter and is pressurized with compressed air to blow jelled fuel out of the fuel lines and a new fuel filter is installed, preferably before the hot fuel is returned to the truck's tanks.

### CROSS-REFERENCE TO RELATED APPLICATIONS

Not Applicable.

### STATEMENT REGARDING FEDERALLY SPONSORED RESEARCH OR DEVELOPMENT

Not applicable.

### SEQUENCE LISTING

Not applicable

### BACKGROUND OF THE INVENTION

The present invention is related to an apparatus and process for changing fuel, particularly diesel fuel, from a jelled partially solid state into a liquid state.

### DESCRIPTION OF THE RELATED ART INCLUDING INFORMATION DISCLOSED UNDER 37 C.F.R. 1.97 and 1.98.

Diesel fuel passes from a liquid state to a semi-solid or jelled state at temperatures commonly encountered in winter when trucks, buses and so forth are expected to be operating. When diesel fuel jells, it cannot be pumped by a standard fuel pump and fuel lodged in the fuel filter and vehicle fuel lines also jells, preventing the engine from running. Diesel fuel used until recently jells at −22° C. (−8° F.). The recently introduced ultra-low sulfur (USL) Diesel fuel, however, begins to jells at 0° C. (32° F.) and is totally jelled at −10.8° C. (0° F.). These temperatures are routinely encountered in many parts of the country during winter. The change in the state of diesel fuel has always been a problem because at cold temperatures, the fuel cannot be pumped conventionally into diesel engines and so trucks, buses and the like cannot operate. Of course, above-ground outdoor storage tanks and like also suffer from this problem, which is a bigger problem now that ultra low sulfur fuel has been mandated by the federal government.

Trucks that cannot operate due to jelled fuel are sometimes stranded on the highway. The only recourse now is to call a tow truck, which tows the affected truck to a truck stop, where a truck often waits for several days before it can be moved into an enclosed space where the fuel thaws out over a period of many hours. The lost productively and the costs of towing are substantial.

This problem can be prevented by adding a fuel additive to the fuel in the truck tanks, but the additives now available typically cost about $60 per tank. Since a truck may refuel everyday, the cost is substantial. Consequently many fleet operators find it cheaper not to use any additives and address the jelled fuel problem when it arises.

Other approaches to attempting to solve this problem involve heating the fuel in the tanks. Most of the devices for addressing this problem seem to fall into one of two categories. Either they use heat from the engine to try to warm the fuel or electricity from the engine to heat the fuel. Most fail because they only operate when the engine is running and they do not provide sufficient heat or they do nothing to the fuel in the tanks.

For example, United States Patent Application Publication Number US 2003/0127076 A1, disclosing an invention by Wijaya and published on Jul. 10, 2003, discloses a Fuel-Heating System for Diesel Engine comprising a cylindrical shell like an oil filter housing seated about the fuel filter with heated engine coolant from the engine radiator being introduced through a tube and returned to the radiator through an exit tube. Alternatively, a portion of the fuel line is wrapped around the exhaust pipe so that the flowing fuel is heated by the exhaust gas passing through the exhaust pipe. Both of these systems obviously only operates while the engine is running and do nothing for the fuel in the tank.

U.S. Pat. No. 6,112,713, issued to Kiel on Sep. 5, 2000, discloses a Diesel Engine Pre-Heater that uses exhaust gases from the running engine to heat engine coolant, supposedly getting the engine up to operating temperature faster, and can also be used to preheat the fuel. These objectives are achieved by installing a heat exchanger box in the exhaust system. This system obviously operates only while the engine is running and does nothing for the fuel in the tank.

U.S. Pat. No. 5,649,515, issued to Fuchs et al. on Jul. 22, 1997, discloses a Diesel Fuel Preheater for Engines. This patent is from a continuation-in-part application of based on U.S. Pat. No. 5,243,953. In Fuchs et al., A diesel fuel preheater receives engine coolant through a tube, transferring it into a heat exchanger 6, thereby heating the passing fuel. Additionally, an electrical heating coil is connected between the positive and negative battery. The electric heater is used during cold starts, while the coolant heat exchanger is used during engine operation. Obviously the liquid heat exchanger operates only while the engine is running and the battery-based system has only very limited power available. Neither heater does anything for the fuel in the tanks or fuel lines because they only heat fuel that flows through the heater. If the fuel is jelled in other parts of the fuel delivery system, these heaters will be of little benefit.

U.S. Pat. No. 5,215,065, issued to Snyder on Jun. 1, 1993, discloses a Diesel Vehicle Fuel Heater System, comprising a heat exchange tube connected to the engine cooling system at the water pump inlet for cooled coolant return and in the coolant line leading to the truck heater, for heating fuel flowing through an in-line fuel heater valve. This system also cannot function unless the engine is running and does nothing to fuel in the fuel tank.

U.S. Pat. No. 5,050,796, issued to Raethel et al. on Sep. 24, 1991, discloses a Fuel Preheating Device for a Heater, comprising a coiled heat exchanger placed inside the exhaust system (FIG. 2). Fuel is circulated through the coil prior to being fed into a burner. Alternatively, the fuel may be heated by heated engine coolant. This system obviously cannot operate without the engine running, does nothing for the fuel in the tanks and cannot function at all until the engine is hot. Clearly this system cannot address the issue of fuel jelled so stiff that it cannot be pumped by the engine fuel pump.

U.S. Pat. No. 5,005,551, issued to McNelley on Apr. 9, 1991, discloses an In-Line Fuel Heater, comprising a system in which a heated working fluid is pumped through a heat exchanger that heats flowing fuel and through a separate heat exchanger placed inside the fuel tank. The heated working fluid can be heated engine coolant or heated returning fuel from the engine that has not been burned or heated oil from the engine crankcase. This system obviously cannot function without the engine running and cannot provide any significant heat to the fuel until the engine is hot.

U.S. Pat. No. 4,343,283, issued to Shepherd on Aug. 10, 1982, discloses a Diesel Engine Fuel Preheating System, comprising a system using heated engine coolant introduced into a heat exchanger coil to heat fuel in a heating tank, which is pumped directly into the engine. This system obviously cannot work unless the engine is running and does nothing for the fuel in the tanks.

U.S. Pat. No. 4,180,036, issued to Wolf on Dec. 25, 1979, discloses a Fuel Temperature Control comprising an electrical heating element connected to a power source for heating a heat exchanger through which fuel is pumped just prior to entering the engine. A thermostat controls an electrical rely, which shuts off the electricity to the heat exchanger to prevent the fuel from becoming too hot. This system cannot function, indeed, has no purpose, unless the engine is running. Nor does it do anything for the fuel in the tank.

U.S. Pat. No. 3,989,019, issued to Brandt et al. on Nov. 2, 1976, discloses a Fuel Heating Apparatus comprising a heat exchanger having a shell with a heat transfer coils inside it. Heated engine coolant is pumped through the coils, which fuel is pumped through the shell 40. An electrical heating can be plugged into a standard electrical outlet to heat the shell when the engine is not running. This system obviously cannot heat any fuel in the fuel tank and cannot operate without either having the engine running or ready access to a standard electrical outlet.

U.S. Pat. No. 3,768,730, issued to Campbell on Oct. 30, 1973, discloses a Fuel Pre-Heater comprising a pipe for returning hot unburned fuel from the engine to the fuel tank to heat the fuel in the tank. The hot return fuel can be diverted to another tank or returned to the first tank. This system cannot work without having the engine running. Since relatively little unburned fuel is returned to the fuel tank, any benefit from the resulting heating is limited.

Each of the above references utilize the heat from a hot running engine or the electricity from a battery, which must be replaced by an engine-operated alternator. None of them will operate unless the fuel can be pumped by a standard fuel pump. Nor do any of them address jelled fuel in the fuel tank or most fuel lines.

Also available are electrically heated slender heat exchanger that are placed inside the fuel tanks through the filler neck. These tend to be slender with a simple looped heat exchanger. They are ineffective in thawing jelled fuel and may or may not impart sufficient heat to the fuel to keep it flowing through fuel lines. It cannot operate for long without a source of significant power, typically derived from a running engine and will not thaw an entire fuel system. These are not widely used because they are relatively expensive, so that most fleet operators will not pay for them, and they are not actually effective.

When some or most of the fuel in a diesel system is jelled, the oil filter is often a serious obstacle to operation of the engine because the fuel is jelled in all the pleats and folds of the filter, preventing any effort to pump fuel through it.

Despite the availability of these and other systems, substantial numbers of diesel powered vehicles become stranded on the road during cold weather. The problem can be inconvenient and costly, as when, for example, an entire fleet of school buses will not run and school is cancelled. In the case of trucks, commercial losses can be very large, particular when the load cannot be frozen, for example, wine. Moreover, diesel fuel can, and often does, jell sufficiently to stop the engine from running even after the vehicle has achieved full equilibrium operating temperature, with or without the fuel heating systems described above, resulting in trucks being stranded along the road.

Therefore, a need exists for a process and apparatus for thawing jelled diesel fuel in a vehicle fuel system that can be used along the side of the road; that does not depend on engine heat or engine-generated electricity; that addresses the entire fuel system of the vehicle.

### BRIEF SUMMARY OF THE INVENTION

Accordingly, it is a primary object of the present invention to provide a process and apparatus for thawing jelled diesel fuel in a vehicle fuel system that can be used along the side of the road.

It is another object of the present invention to provide a process and apparatus for thawing jelled diesel fuel in a vehicle fuel system that does not depend on engine heat or engine-generated electricity.

It is another object of the present invention to provide a process and apparatus for thawing jelled diesel fuel in a vehicle fuel system that addresses the entire fuel system of the vehicle.

These and other objects of the present invention are achieved by providing a high-powered pump to pump the jelled fuel out of the truck's fuel tanks into a holding tank where heat exchangers transfer heat from heated propylene glycol to the jelled fuel, heating it to about 40-50° C. (115-125° F.). Then the heated fuel is pumped back into the truck's fuel tanks. The propylene glycol is heated by a diesel fuel burner. In most cases, the heat from the fuel in the truck's tanks will thaw the fuel in the truck's fuel lines and the engine will start and will run. When the fuel in the truck's tanks has been heated to about 40-50° C. (115-125° F.), the fuel nearly always holds enough heat to prevent any re-jelling of the fuel until all that fuel has been consumed.

In the case where the heated fuel in the truck's fuel tanks will not thaw the rest of the fuel system, the fuel filter is removed and is replaced by a fuel filter shell having an compressed air hose receiving air chuck fitting on it. A source of compressed air is connected to the fuel filter shell and compressed air is used to blow out the jelled fuel line, with the jelled fuel being forced from the fuel filter back to the fuel tank. The compressed air is connected to the fuel line on both sides of the fuel filter, but cannot flow toward the engine because the fuel injectors are closed. Thus, at the end of the compressed air purging, fuel line between the fuel filter and the fuel tank is empty. The heat from the heated fuel thaws the remainder of the fuel line. This process does not damage the fuel lines or injectors. Then the fuel filter shell is replaced with a new fuel filter and the trucker is ready to be on the road again. Anytime a vehicle suffers from jelled fuel, the fuel filter must be replaced because it is virtually impossible to thaw the fuel filter and return it to operation.

An apparatus for thawing jelled diesel fuel in a vehicle fuel system according to the present invention can be configured for station use, as at a truck stop, or for mounting onto a vehicle service truck for mobile use in the field or in other configurations. It is believed that the mobile service truck configuration will be most helpful and welcome and will spare truckers much inconvenience and expense.

Other objects and advantages of the present invention will become apparent from the following description taken in connection with the accompanying drawings, wherein is set forth by way of illustration and example, the preferred embodiment of the present invention and the best mode currently known to the inventor for carrying out his invention.

### BRIEF DESCRIPTION OF THE SEVERAL VIEWS OF THE DRAWING

FIG. 1 is side view of an apparatus for thawing jelled diesel fuel in a vehicle fuel system according to the present invention.

FIG. 2 is an isometric view of a fuel filter shell and filter cap for use in connection with a process of using the present invention.

FIG. 3 is an isometric view of the tank of FIG. 1 shown partially cut away.

FIG. 4 is a cross section taken along the lines 4-4 of FIG. 1 and showing top view of the tank of FIG. 1 with the top removed, that is, showing the bottom wall of the tank and the heating elements above the floor.

FIG. 5 is a schematic side view of a burner for use in the fuel heating apparatus of FIG. 1.

FIG. 6 is a schematic side view of a diesel engine showing the flow of the fuel system and the purging of jelled fuel from the system in accordance with the present invention.

FIG. 7 is a flow chart showing a basic process for using the apparatus of FIG. 1 suitable for use with a vehicle such as a truck, bus or the like.

FIG. 8 is a flow chart showing an expanded version of the process of FIG. 7 and adding a step performed by the apparatus of FIGS. 1, 6.

FIG. 9 is a flow chart showing expanded steps of step three of FIG. 8, which is purging the fuel lines in a motor vehicle of jelled fuel.

### DETAILED DESCRIPTION OF THE INVENTION

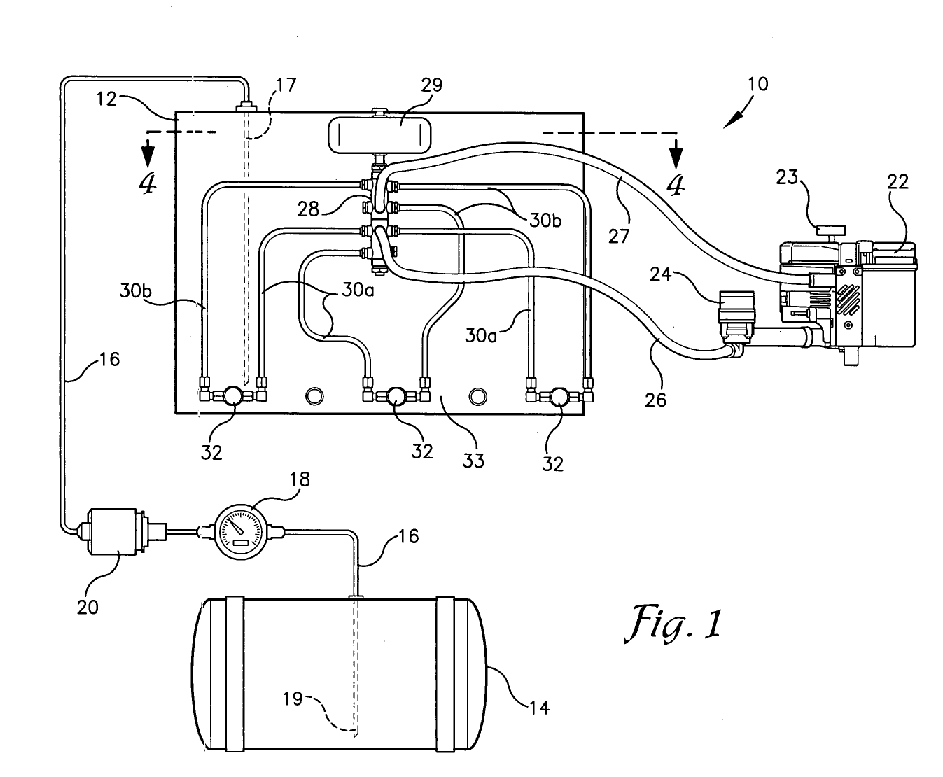

Referring to FIG. 1, an apparatus for thawing jelled diesel fuel in a vehicle fuel system according to the present invention (fuel thawing apparatus) 10 includes a fuel heating tank 12 connected to a vehicle fuel tank 14 (which may be one, two or more separate fuel tanks, target tank 14, which is any tank from which jelled fuel may be withdrawn and includes stationary tanks as well as vehicle tanks) by the hose 16, which has a fuel volume meter 18 and a pump 20, which is a powerful hydraulically powered gear-driven or gear pump having sufficient drawing and pumping power to draw jelled fuel out of the vehicle fuel tank 14 and to covey it to the heating tank 12. The vehicle fuel tank 14, or target fuel tank 14, may be any container or tank having jelled fuel inside it, such as an above-ground storage tank. The end 19 of the hose 16, or a tube 19 inserted into the vehicle fuel tank 14 and connected to the hose 16, extends to very nearly the bottom of the truck's fuel tank 14. In the case of multiple tanks, the fuel is separately extracted from each tank 14 prior to treating the fuel by heating in the heating tank 12. Obvious design choice allows for fuel to be removed from more than one truck fuel tank at the same time. The volume meter 18 allows the operator to assure a trucker that the full volume of fuel removed from his vehicle fuel tank 14 is the same as the volume of fuel restored to the vehicle fuel tank 14 after treatment with the fuel thawing apparatus 10. A conventional fuel pump will not produce sufficient power to move the jelled fuel. A diesel fuel fired burner 22 heats a working fluid, preferably propylene glycol, that is contained in a closed loop of heat exchangers 32 and a working fluid pump 24 connected through the inlet hose 26 into the distribution manifold 28, then through the distribution lines 30a, 30b into the heat exchangers 32 and is returned through the return hose 27. The hot propylene glycol is pumped into the heat exchanger distribution manifold 28 and through it into the inlet lines 30a, which lead to the inlet tubes of the heat exchangers 32, through the heat exchangers 32 and out through the outlet return lines 30b. Each inlet distribution line 30a is always lower than the corresponding outlet return distribution line 30b to prevent the possibility of developing an air lock, as any bubbles in the working fluid will tend to float and can easily be pushed upward, whereas attempting to push them downward might lead to a vapor lock. The heat exchangers distribution manifolds 28 are conventional commercially available manifolds with internal passageways that distribute the working fluid as designed. The heat exchanges 32 have an inlet and an outlet on the same face, i.e., they pass through only a single side wall of the heating tank 12 and are single loop type having a U-shaped distal end, turning from the end of the inlet passage to form an outlet passage. There are three heater exchangers 32 in the right-hand sidewall 33 and four on the left-hand side wall 35. It has been found through experimentation that three or four of the heat exchangers 32 are usually sufficient to thaw a full load of jelled diesel fuel for a large truck, which normally have two fuel tanks each having a capacity of about 455-570 liters (120-150 U.S. gallons), with most large trucks having a maximum fuel capacity of 900-1,150 liters (240-300 U.S. gallons), and heat it to the target temperature range of 40-50° C. (115-125° F.) in about 30 minutes. The heating tank 14 is large enough to hold the entire fuel capacity of a large truck or the like. The number, type or design, capacity and location of the heat exchangers 32 is highly flexible depending on the design parameters of a particular system for a specific situation.

Still referring to FIG. 1, in any case, it is desirable to measure the volume of diesel fuel drawn from the target tank 14 using the volume meter 18 and recording the resulting volume of fuel and then recording the volume of fuel that is returned to the target tank 14 after heating and recording the volume of diesel fuel that is returned to the tank 14 to assure the customer that no fuel was improperly retained. The diesel fuel expands when heated, making exact comparisons unrealistic, but they are close enough to insure against retaining fuel in the heating tank 12. More exact measurements could be made using the weight of the diesel fuel instead of the volume. In either case, the quantity of fuel removed from the target tank 14 and returned to it after heating is measured.

Still referring to FIG. 1, a small volume of liquid diesel fuel, about 190-460 liters (50-110 U.S. gallons), may be left in the heating tank 12 permanently, just enough to cover the heat exchangers 32, to insure that the heat exchangers are never heated while exposed to the air, which might result in overheating. This has no effect on heating of the jelled diesel fuel and is wholly optional.

Still referring to FIG. 1, propylene glycol is a colorless, viscous, liquid used as an antifreeze, a solvent and in organic synthesis. It has been found that it provides a good working fluid for transferring heat from one place to another, particularly in low temperature applications, in connection with the fuel thawing apparatus 10. Other liquids or gasses could also be employed. The working fluid heating and heat transfer system including the heat exchangers 32, the distribution manifold 28, the distribution lines 30a, 30b, the burner 22 heating element, which is preferably an elongated metallic coil that the burner flame projects into, the pump 22 and associated inlet hose 26 and return hose 27 form a closed sealed system, with a vented expansion tank 29 mounted to the top of the distribution manifold 28 to absorb and then release the increase or decrease in the volume of the propylene glycol due to temperature changes. One such identical set of inlet hose 26 and return hose 27 are used for each distribution manifold 28. Using the distribution manifolds 28 that are operatively connected to the distribution lines 30a, 30b and the heat exchangers 32 simplifies the apparatus and saves expenses by eliminating the need to run two distribution lines for each heat exchanger 32 to the burner 68. Instead only one pair of working fluid lines needs to be run to each distribution manifold 28, thereby reducing the number and length of distribution lines.

Still referring to FIG. 1, a thermostat controller 23 allows the operator to control a thermostat inside the heating tank 12, and to set the desired temperature of the diesel fuel inside the heating tank 12. When the preset temperature has been reached, the burner 22 shuts off automatically and the pump 20 is turned on in the opposite direction, returning the heated fuel to the vehicle fuel tank 14. That is, the pump 20 is used for removing jelled diesel fuel from a target tank 14 and transferring the jelled diesel fuel to the heating tank 12 and, after the jelled diesel fuel has been heated to the desired temperature, returning, or moving, the heated diesel fuel back to the target tank 14. It has been found that about 40-50° C. (115-125° F.) is a desirable temperature because fuel this warm will likely remain in a liquid state until it is all consumed by the engine.

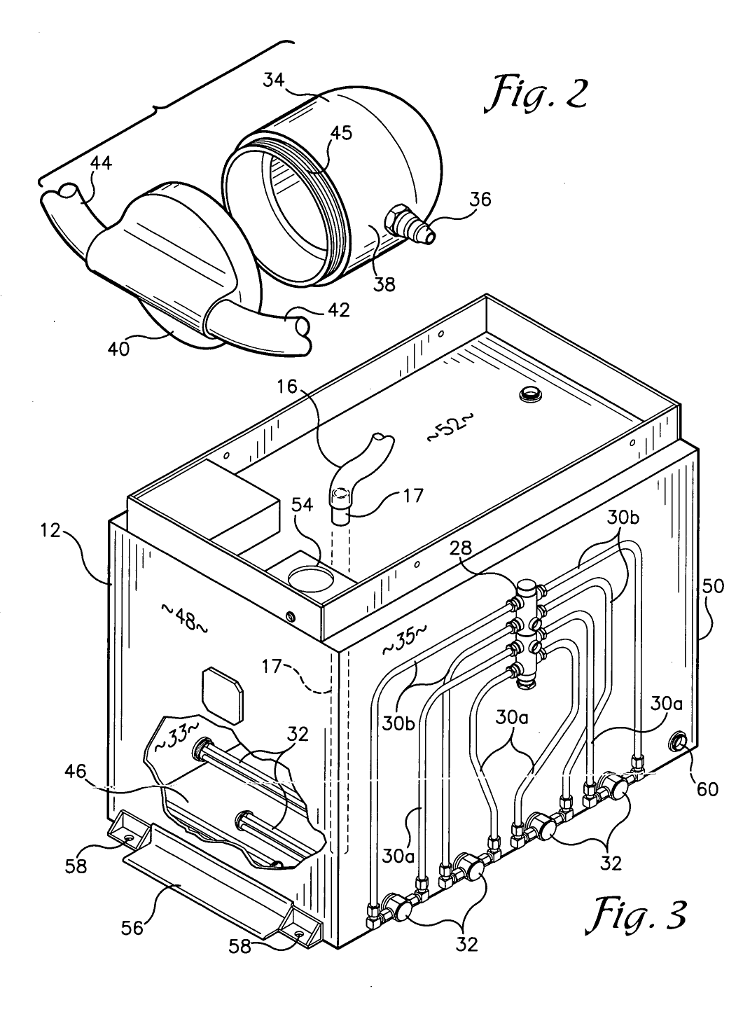

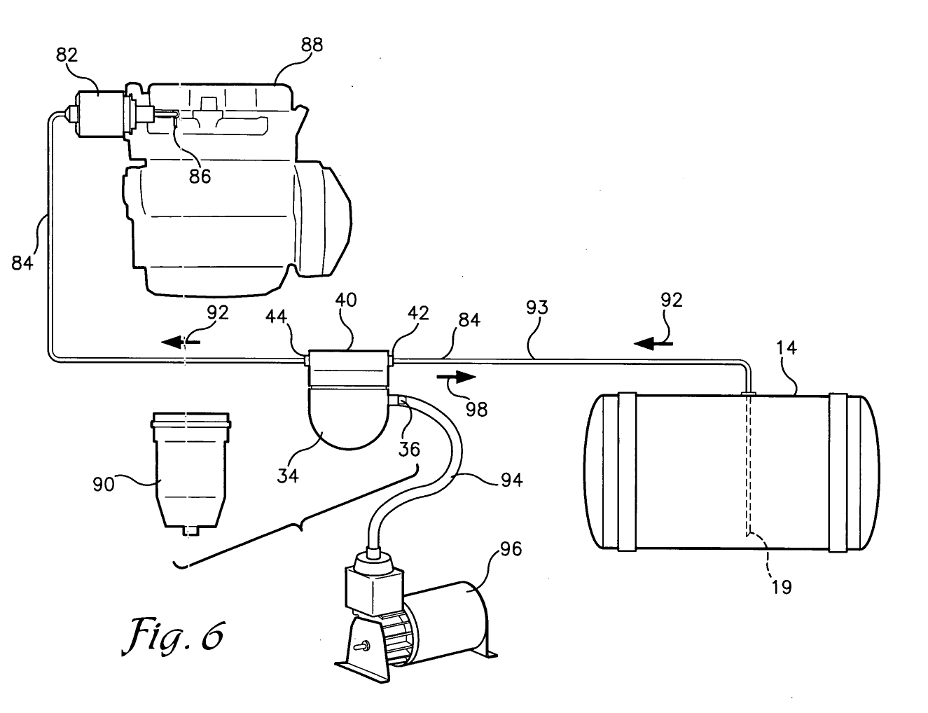

Referring to FIG. 2, there is shown a fuel filter shell 34, which consists of a hollow shell with no filter material inside of it, with an air chuck fitting 36 fixed to the side wall 38. In use, as shown in detail in FIG. 6, the fuel filter is removed by unscrewing it from the filter cap 40 and the fuel filter shell 34 is screwed onto the filter cap 40, replacing the fuel filter. A compressed air hose is connected to the air chuck fitting 36 and compressed air is turned on to clear the vehicle fuel line from the filter back to the vehicle fuel tank 14 of jelled fuel. The fuel filter shell 34 air chuck fitting 36 of the fuel filter shell 34 provides for fluid communication between a hollow interior of the fuel filter shell 34 and the ambient atmosphere when the fuel filter shell 34 is connected to and sealed to a sealed fuel system for use in purging jelled diesel fuel from vehicle fuel lines (or any type of lines from a stationary tank, such as an above-ground bulk tank). Installation of a new fuel filter then makes the truck ready to drive. All in about 30 minutes, saving the trucker and trucking company thousands of dollars in direct costs and loss prevention. The fuel filter cap 40 includes a fuel inlet fitting 42 and a fuel outlet fitting 44. The fuel filter cap 40 includes internal female threads that mate with the external male threads 45 on the open edge of the fuel filter shell 34.

Referring to FIG. 3, the heating tank 12 includes a bottom wall 46, the left-hand side wall 35, the right-hand side wall 33, a rear side wall 48, a front side wall 50 and a top wall 52 fixed together to form a rectilinear hollow shape. A hole 54 in the top wall 52 provides an alternative mounting site for the pump 20. The hose 16, is connected to a fill tube 17 that drops into the heating tank 12 close to its bottom wall 46 to allow most of the diesel fuel in the holding tank to be returned to the vehicle fuel tank 14. The distal end of the fill tube 17 terminates about 1-1.5 cm (2.5-3.5 inches) above the bottom wall 46 of the heating tank 12 so that some diesel fuel remains in the heating tank 12 at all times so that the heat exchangers 32 are never heated without being in contact with diesel fuel. A flange fitting 56 fixed to the bottom edge of the rear side wall 48 and to the front side wall 50 includes bolt holes 58 to allow the heating tank 12 to be secured to a floor, such as the bed of a vehicle service truck. The four heat exchangers 32 are clearly visible on the left-hand side wall 33, with their bodies shown in the cutaway portion of the rear side wall 48. A drain cock 60 allows the heating tank 12 to be drained for cleaning and so forth.

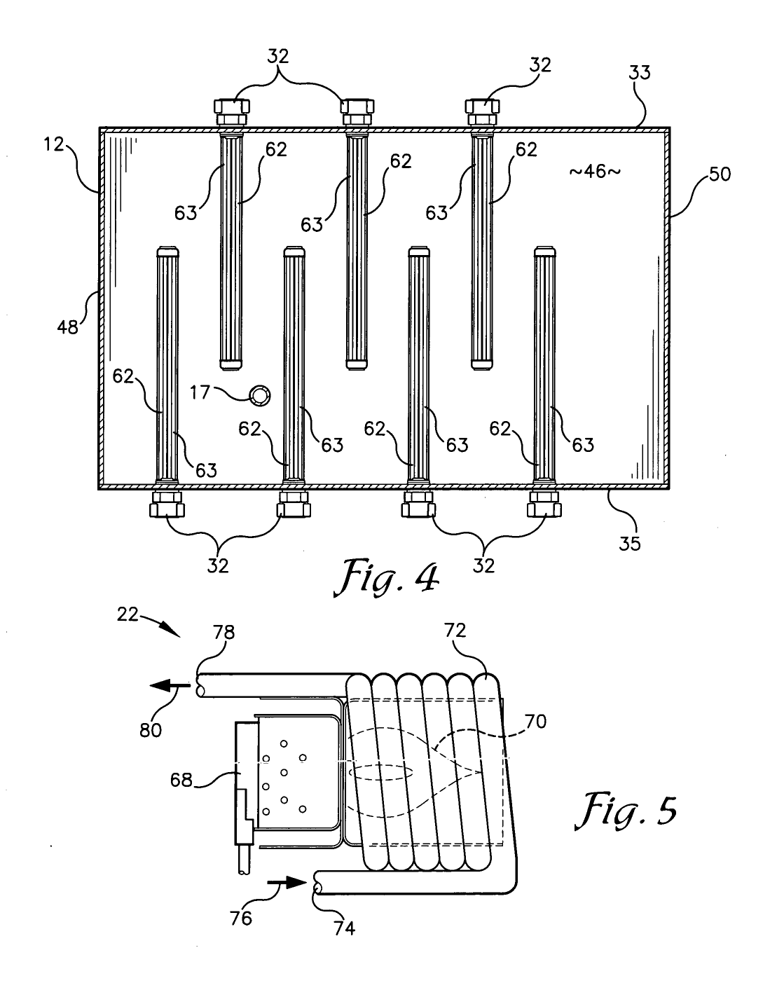

Referring to FIG. 4, each heat exchanger 32 includes a working fluid inlet tube 62 and a return working fluid outlet tube 64. While passing through the heat exchanger tubes 62, 64, which are submerged in diesel fuel, with working fluid propylene glycol surrenders much of its heat before it flows back to the burner 22.

Referring to FIG. 5, the diesel fuel fired burner 22 includes a burner body and controls 68 that projects a flame 70 into an elongated heat exchange metallic coil 72 formed like a coil spring. The working fluid flows into an inlet port 74 in the direction of the inlet arrow 76 and, after passing through the heat exchange coil 72 and absorbing heat from the flame 70, exits through the outlet port 78 in the direction of the outlet arrow 80 to be circulated through the heat exchangers 32. These and other associated part form a closed loop tube system conveying the heated working fluid through the heat exchangers 32 and back to the burner 68 and the working fluid pump 24. The burner body and controls 68 further include, as an integrated factory installed safety system, a thermostat and connected automatic shut-off valve to prevent overheating of the burner 68. The burner 68 and associated hardware as described are used for imparting heat to the heating tank 14 and its contents. In the fuel thawing apparatus 10 as described, the heating tank 12 has a volume of about 1,550 liters (400 U.S. gallons) and the temperature of the working fluid leaving the burner 68 is about 110.7° C. (242° F.), which is just below the boiling point of propylene glycol, and the temperature of the working fluid returning to the burner is typically about 110° C. (230° F.). The amount of heat transferred to the jelled diesel fuel and the resulting heat loss in the working fluid depend on a number of factors, such as the efficiency of the heat exchangers 32, the extent of jelling of the diesel fuel, the quantity of jelled diesel fuel being heated, ambient temperature and other factors and can be moderated, within limits, as desired by adjusting the burner fuel or flame 70, capacity of the metallic coil 72, size and nature of the heat exchangers 32 and so forth. Referring to FIG. 6, there is shown the additional components needed to restore a vehicle suffering from jelled fuel to operation. These components are separate from the heating tank 12 and associated hardware described above. Jelled fuel in the vehicle fuel system must be removed, particularly in the fuel filter 90 because even hot diesel fuel in the vehicle fuel tank 14 cannot be pumped through the jelled fuel system. Therefore, the process of restoring the vehicle to operation includes the further step of purging the vehicle fuel lines of jelled fuel. Otherwise the fuel pump 82 on the vehicle engine 88 will not be able to pump the now heated fuel through the vehicle fuel lines 84 and the fuel filter 90. In ordinary operation, the fuel pump 82 draws diesel fuel from the vehicle fuel tank 14 through the vehicle fuel line 84, which draws fuel from the bottom of the vehicle fuel tank 14 as shown by the representational tube 19, and into the fuel injectors 86 inside the engine 88 for combustion. Disposed along the vehicle fuel line 84 is a fuel filter 90, shown to the side of the assembly in FIG. 6, as it must be removed and discarded. The fuel normally flows in the direction of the fuel flow arrows 92. When the fuel has jelled and the engine 88 cannot operate, the fuel filter 90 is removed and discarded. It is then replaced by the fuel filter shell 34; an air compressor hose 94 is connected to the air chuck fitting 36 and compressed air from the air compressor 96 is forced into the fuel filter shell 34, which forces compressed air into the vehicle fuel lines 84. Because the fuel injectors are closed, the compressed air cannot force the fuel between the fuel filter shell 36 and the engine 88 to move, but it does force the jelled fuel between the fuel filter shell 34 and the vehicle fuel tank 14 backwards along the direction of the purging arrow 92 back into the vehicle fuel tank 14, that is, along the vehicle purging fuel line segment 93, where it will be melted by the hot fuel that is returned to the vehicle fuel tank 14. Because the fuel filter 90 is much closer to the engine 88 than the vehicle fuel tank 14, the fuel pump 82 can draw hot fuel to the little remaining jelled diesel fuel in the vehicle fuel line quickly thaws, allowing the engine 88 to operate. After the vehicle fuel line segment 93 has been purged of jelled fuel, the fuel filter shell 34 is removed and is replaced by a new fuel filter 90. The old fuel filter has been ruined by the jelled fuel. The vehicle fuel line purging segment 93 can be purged either before or after the heated fuel in returned to the vehicle fuel tank 14, but purging the line 93 prior to returning the heated fuel to the vehicle fuel tank 14 for safety reasons.

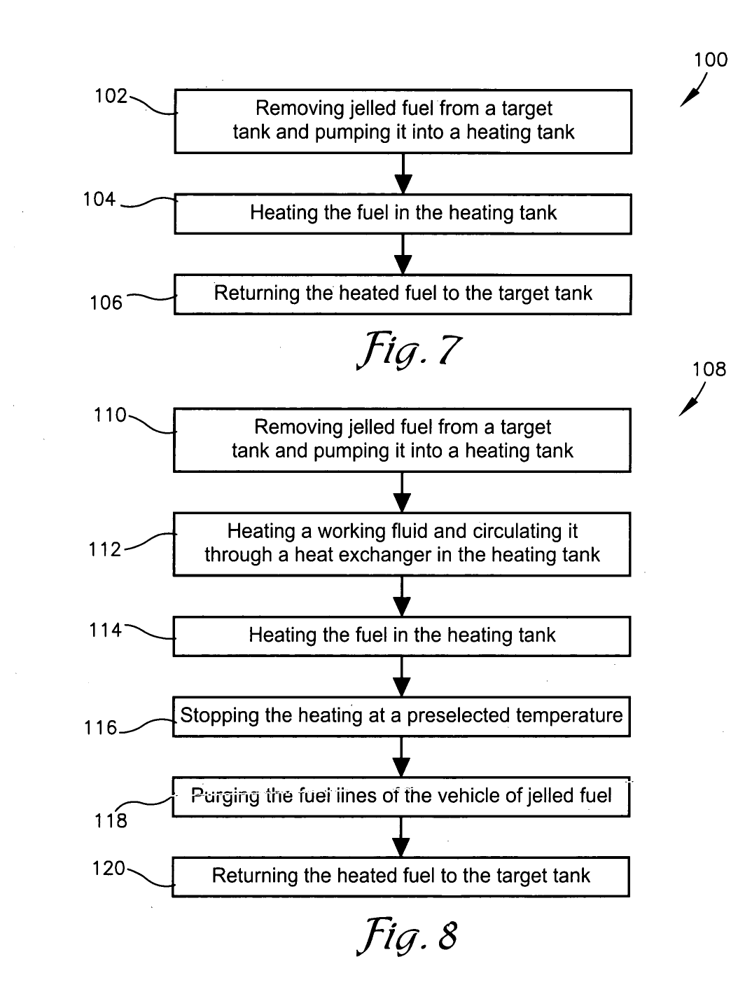

Referring to FIG. 7, a basics process for using the fuel thawing apparatus 10 includes the sequential steps 100 of (1) removing jelled fuel from a target tank, as the vehicle fuel tank 14, and pumping the fuel into a heating tank 12 102; (2) heating the jelled diesel fuel in the heating tank 12 104; and (3) returning the heated diesel fuel to the target tank 14 106. An apparatus suitable for carrying out this and other processes described below is disclosed in the above description and prior figures.

Referring to FIG. 8, a more detailed process 108 includes the substantially sequential steps of (1) removing jelled diesel fuel from a target tank 14 and pumping it into a heating tank 12 110; (2) heating a working fluid and circulating through a heat exchanger 32 in the heating tank 12 112; (3) thereby heating the jelled diesel fuel in the heating tank 12 114; (4) stopping the heating at a preselected temperature 116 (while it is possible to heat the jelled diesel fuel only sufficiently to return it to a completely liquid state, it is preferable to the diesel fuel into a range of about 40-50° C. (115-125° F.), which is generally sufficiently hot to ensure that the diesel fuel will remain fully liquid until consumed by the engine 88); (5) purging the fuel lines of the vehicle of jelled fuel 118; and returning the heated diesel fuel to the target tank 14 120. Step number 118 can be performed after step 120 returning to heated fuel to the target tank 14, but preferably each of the steps shown in FIG. 7 is performed in the sequence shown. In many cases, step 118 of purging the fuel lines of the vehicle of chilled fuel can be performed while the fuel is heating in the heating tank 114, thereby saving time for the entire operation of restoring a vehicle to operate condition. Of course, this somewhat out of sequence process is possible because the physical space in which the heating of the fuel 114 and the purging of the fuel lines of the vehicle 118 is different at the equipment used for each of these steps is different, allowing them to be carried out separately.

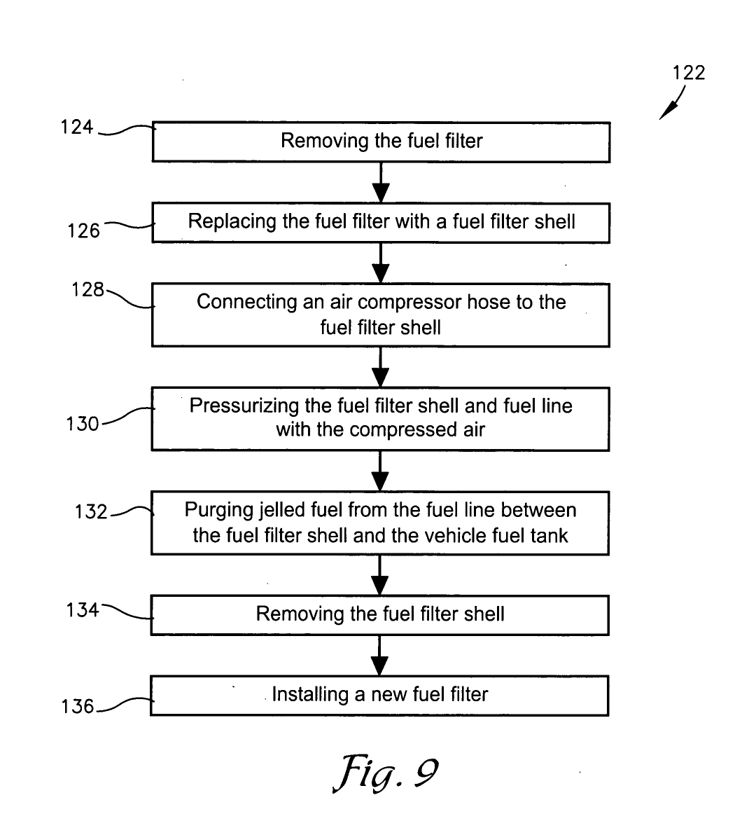

Referring to FIG. 9, the step of purging the fuel lines of the vehicle of jelled diesel fuel 118 shown in FIG. 8, as expanded here to provide a complete set of sequential steps needed to purge the fuel lines. The purging step as shown in FIG. 9 122 includes the steps of (1) removing the fuel filter from the vehicle 124 (which must be properly discarded); (2) replacing the fuel filter what they fuel filter shell 34 126; (3) connecting an air compressor hose 94 to the fuel filter shell 34 128; (4) pressurizing the fuel filter shell 34 and the fuel line with compressed air from the air compressor 96 130; (5) thereby purging the jelled diesel fuel from the portion of the fuel line of the vehicle between the fuel filter shell 34 and the vehicle fuel tank 14 by forcing the jelled diesel fuel back into the vehicle fuel tank 14 132; (6) then removing the fuel filter shell 34 134; and (7) installing a new fuel filter. Again, whenever the fuel in a vehicle fuel system jells, the fuel filter is ruined and must be replaced with a new one. Again, purging only a portion of the vehicle fuel line 93 is sufficient because the hot fuel will melt any remaining jelled fuel in the fuel system.

While the present invention has been described in accordance with the preferred embodiments thereof, the description is for illustration only and should not be construed as limiting the scope of the invention. Various changes and modifications may be made by those skilled in the art without departing from the spirit and scope of the invention as defined by the following claims. For example, other means for heating the jelled fuel can be devised, such as projecting a flame directly into heat exchanger tubes in the heating tank, using other working fluids, using other types of heat sources to heat a working fluid, using a weight meter instead of a volume meter to measure transferred fuel and so forth.

I claim:

1. An apparatus for thawing jelled diesel fuel comprising:
a. a heating tank;
b. means for imparting heat to said heating tank and the contents of said heating tank seated inside said tank;
c. means for removing jelled diesel fuel from a target tank and transferring the jelled diesel fuel to said heating tank; and
d. means for moving the fuel from said heating tank to the target tank after heating.

2. An apparatus in accordance with claim 1 wherein said means for imparting heat further comprises at least one heater exchanger seated in said heating tank.

3. An apparatus in accordance with claim 2 further comprising a burner outside of said heating tank for heating a working fluid inside a closed loop tube system conveying the heated working fluid through said at least one heat exchanger and back to said burner and means for pumping said working fluid through said closed loop tube system.

4. An apparatus in accordance with claim 3 further comprising means for setting and controlling the temperature of the fuel in said heating tank.

5. An apparatus in accordance with claim 1 wherein said means for removing the jelled diesel fuel from a target tank and transferring the jelled diesel fuel to said heating tank and said means for moving the fuel from said heating tank to the target tank after heating further comprises a hose connected to a pump, with one end of said hose being disposed inside a target tank and the other end of said hose disposed in said heating tank.

6. An apparatus in accordance with claim 5 further comprising a measuring meter disposed in said hose for measuring the quantity of jelled diesel fuel removed from the target tank and the volume of heated fuel returned to the target tank.

7. An apparatus in accordance with claim 1 further comprising a fuel filter shell having an air chuck valve fixed to said fuel filter shell for fluid communication between a hollow interior said fuel filter shell and the ambient atmosphere when said fuel filter shell is connected to and sealed to a sealed fuel system for use in purging jelled diesel fuel from fuel lines.

8. An apparatus in accordance with claim 1 further comprising means for securing said heating tank to a vehicle service truck.

9. An apparatus for thawing jelled diesel fuel comprising:
a. a heating tank
b. at least one heat exchanger seated in said heating tank and operatively connected to a working fluid heated by a burner and circulated by means of a pump and connected means for controlling the temperature of fuel inside said heating tank;
c. a pump and associated means for removing jelled diesel fuel from a target tank and transferring the jelled diesel fuel to said heating tank; and
d. means for moving the fuel from said heating tank to the target tank after heating.

10. An apparatus for thawing jelled diesel fuel in accordance with claim 9 wherein said at least one heat exchanger further comprises a plurality of heat exchangers operatively connected to at least one heat exchange manifold whereby the lengths of working fluid distribution lines is reduced.

11. A process for thawing jelled diesel fuel in a motor vehicle and thereby restoring the motor vehicle to operating condition comprising the steps of:
a. removing the jelled diesel fuel from a target tank and pumping the jelled diesel fuel to a heating tank;
b. heating the jelled diesel fuel in said heating tank; and
c. returning the now heated diesel fuel to said target tank.

12. A process in accordance with claim 11 wherein step b further comprises heating the diesel fuel to a temperature in the range of 40-50° C. (115-125° F.) before carrying out step c of claim 11.

13. A process in accordance with claim 11 wherein step b further comprises heating a working fluid outside of said heating tank and circulating said working fluid through at least one heat exchanger seated in said tank.

14. A process in accordance with claim 11 further comprising the step of purging jelled diesel fuel from the vehicle fuel lines.

15. A process in accordance with claim 14 wherein the step of purging jelled diesel fuel from the fuel lines of the vehicle is carried out prior to step c of claim 11.

16. A process in accordance with claim 14 wherein the step of purging jelled diesel fuel from the fuel line of the vehicle further comprises the steps of:
a. removing the vehicle fuel filter;
b. sealing the resulting open fuel filter fitting; and
c. purging jelled diesel fuel from the vehicle fuel lines.

17. A process in accordance with claim 16 wherein said purging step is carried out with compressed air.

18. A process in accordance with claim 16 comprising the further step of replacing the vehicle fuel filter with a new vehicle fuel filter after step c of claim 16.

19. A process in accordance with claim 16 wherein the step of sealing the resulting open fuel filter fitting further comprises the step of installing a fuel filter shell having a air chuck fitting.

20. A process in accordance with claim 17 wherein the step of purging the jelled diesel fuel from the fuel lines using compressed air further comprises the sequential steps of installing a fuel filter shell having a air chuck fitting in place of the fuel filter, connected a source of compressed air to said air chuck fitting and allowing compressed air to flow through said air chuck fitting, said fuel filter shell and the vehicle fuel lines between said fuel filter shell and a vehicle fuel tank, whereby jelled diesel fuel in the vehicle fuel lines is forced back into the vehicle fuel tank, where it will be melted and heated by the heated diesel fuel returned to the vehicle fuel tank in step c of claim 11.
